(19) United States
(12) Patent Application Publication
(10) Pub. No.: US 2022/0258532 A1
(43) Pub. Date: Aug. 18, 2022

(54) RAPID REFUELING

(71) Applicant: Paha Designs, LLC, Felt, ID (US)

(72) Inventor: Benjamin Meager, Felt, ID (US)

(21) Appl. No.: 17/673,254

(22) Filed: Feb. 16, 2022

Related U.S. Application Data
(60) Provisional application No. 63/149,987, filed on Feb. 16, 2021.

(51) Int. Cl. B60B 29/00; B60S 5/02; B60K 7/00

(52) U.S. Cl. CPC B60B 29/00; B60K 7/0007; B60S 5/02

(57) ABSTRACT

A system and method for refueling a vehicle are described. An illustrative refueling system is taught to include a lift configured to lift and lower a vehicle frame, a coupling and coupling receiver that releasably connect a wheel to the vehicle frame, and a wheel travel lane that enables a replacement wheel to be rolled underneath the vehicle frame while the vehicle frame is lifted.

### CROSS-REFERENCE TO RELATED APPLICATION

The present application claims the benefit of U.S. Provisional Patent Application No. 63/149,987, filed on Feb. 16, 2021, the entire contents of which are hereby incorporated herein by reference in its entirety.

### FIELD

The present disclosure relates generally to the field of vehicles. More specifically, it relates to refueling systems and methods for vehicles.

### BACKGROUND

Traditional vehicles employ a centralized motor (e.g., combustion, electric, hybrid, etc.) and translate power generated at the centralized motor to vehicle wheels through a drive train. The drive train traditionally includes one or more rotational elements that transfer rotational motion from the centralized motor to rotational motion of the vehicle wheels. The complexities of many drive trains prohibit certain connections between the vehicle wheels and vehicle frame. Moreover, refueling of traditional vehicles can be a time-consuming process.

### SUMMARY

Embodiments of vehicles, refueling methods for vehicles, and systems used to refuel vehicles aim to overcome shortcomings of traditional systems and methods. For instance, embodiments of the present disclosure contemplate an improved vehicle refueling system and method. Certain embodiments of the present disclosure leverage a unique and efficient vehicle-to-wheel coupling that allows wheels of a vehicle to be replaced easily and efficiently. Moreover, because a wheel of a vehicle may include one or more drive components and/or power supply components (e.g., power supplies, power distribution units, batteries, etc.), providing the ability to quickly change a wheel of a vehicle inherently provide efficient and fast methods for refueling vehicles.

In some embodiments, a refueling system is provided that includes: a lift configured to lift and lower a vehicle frame; a coupling and coupling receiver that releasably connect a wheel to the vehicle frame; and a wheel travel lane that enables a replacement wheel to be rolled underneath the vehicle frame while the vehicle frame is lifted.

According to another embodiment of the present disclosure, a refueling method provided that includes: uncoupling a wheel from a vehicle frame; moving the wheel away from the vehicle frame; moving a replacement wheel in proximity to the vehicle frame; and coupling the replacement wheel to the vehicle frame.

### BRIEF DESCRIPTION OF THE DRAWINGS

The present disclosure is described in conjunction with the appended figures, which are not necessarily drawn to scale:

FIG. 1 is an isometric view of a refueling system with a vehicle in a first position relative thereto in accordance with at least some embodiments of the present disclosure;

FIG. 2 is an isometric view of a refueling system in a second configuration in accordance with at least some embodiments of the present disclosure;

FIGS. 3A-3C illustrate a vehicle in a refueling system in accordance with at least some embodiments of the present disclosure;

FIGS. 4A-4C illustrate a refueling system in a third configuration in accordance with at least some embodiments of the present disclosure;

FIGS. 5A-5C illustrate a refueling system in a fourth configuration in accordance with at least some embodiments of the present disclosure;

FIGS. 6A-6C illustrate a refueling system in a fifth configuration in accordance with at least some embodiments of the present disclosure;

FIGS. 7A-7C illustrate a refueling system in a sixth configuration in accordance with at least some embodiments of the present disclosure;

FIG. 8 is an isometric view of a vehicle exiting a refueling system in accordance with at least some embodiments of the present disclosure; and

FIG. 9 is an isometric view of a refueling system in a seventh configuration in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. Various changes may be made in the function and arrangement of elements without departing from the spirit and scope of the appended claims.

Various examples are provided throughout the following disclosure. The disclosure of examples is in all cases intended to be non-limiting, including specifically when examples are identified with the terms or phrases identifying what follows to be an example, including the terms of phrases “for example,” “as one example,” “such as,” “by way of example,” and “e.g.” In other words, the disclosure of one or more examples is not intended to limit the present disclosure to embodiments conforming to the disclosed example(s).

Embodiments of vehicles disclosed herein may include any number of features. While various examples of vehicles and methods of refueling vehicles will be described with particular features, it should be appreciated that the features depicted and described in connection with a particular vehicle may be used in another vehicle or refueling system without departing from the scope of the present disclosure. Further still, embodiments of the present disclosure contemplate that vehicle wheels or wheel cores may be easily replaced by other wheels or wheel cores. Thus, embodiments of the present disclosure contemplate that wheels of one type or wheel cores of one type may be used to replace wheels of another type or wheel cores of another type.

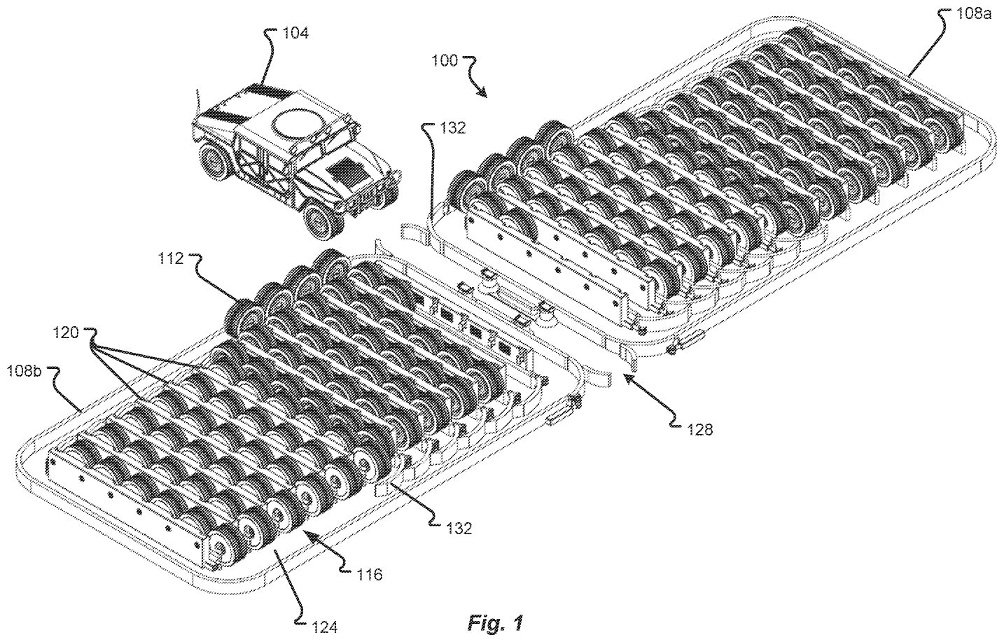

Referring now to FIG. 1, a refueling system 100 is shown to include a first side 108a and second side 108b that are populated with a number of wheels 112. A refueling area 128 may be provided between the first side 108a and second side 108b. The refueling area 128 may be sized to receive a vehicle 104 and to allow a vehicle 104 to pass therethrough and be refueled therein. Both the first side 108a and second side 108b of the refueling system 100 may include a number of wheels 112 organized in a plurality of wheels rows 116. The wheels rows 116 may be maintained with one or more separators 120.

In some embodiments, a plurality of wheels 112 may be provided in wheel rows 116 and at least some of the plurality of wheels 112 may be configured to replace a wheel 112 that is provided on the vehicle 104. Some or all of the wheels 112 may include power supply components (e.g., batteries), power distribution components, power converter components, and the like. One or more of the components of the wheel 112 may be positioned below an axis of rotation of the wheel 112.

Some or all of the wheels 112 may alternatively or additionally include one or more motors that are used to rotate a tire about a rotational axis, thereby provided a drive force to the vehicle 104. In other words, a vehicle 104 may be configured to operate with one or multiple wheels 112 that have internal motors, power supply components, controllers, and other components that enable a propulsion of the wheel 112. Replacing a wheel 112 of this type may enable the vehicle 104 to be refueled (e.g., receive a new and charged power supply or source of rotational energy) in a relatively efficient and quick manner. In other words, because the vehicle 104 may not necessarily utilize a central internal combustion engine or a traditional gas tank to provide propulsion to the vehicle 104, the vehicle 104 may be refueled in a more efficient and time-effective manner. That is, the vehicle 104 may be refueled by replacing one or more of the wheels 112 of the vehicle 104 with another “charged” wheels 112.

The separators 120 may alternatively or additionally include wheel charging components that enable used wheels 112 to be charged or have their power source replenished while in the wheel row 116. Some or all of the separators 120 may be configured as charging stations for the wheels 112 when loaded in the wheel row 116 and when connected to the separator 120. In some embodiments, the first side 108a and/or second side 108b may be configured as mobile units. Accordingly, the first side 108a and/or second side 108b may include one or more chargers provided in the separator 120 that may be powered by external generators, solar cells, wind turbines, or some other power-generation device.

As shown in FIG. 1, a vehicle 104 may approach the refueling system 100 and aim to enter the refueling area 128. Initially, one or more paddles 132 may be closed, thereby restricting vehicle 104 access to the refueling area 128. Meanwhile, one or both of the first side 108a and second side 108b of the refueling system 100 may include a number of additional paddles 132 that help maintain and establish a wheel travel lane 124. Some or all of the paddles 132 may be moved between an open state (e.g., a first state) and a closed state (e.g., a second state) under control of an actuator. When the paddles 132 restricting entry to the refueling area 128 are closed, the vehicle 104 may not be allowed to enter the refueling area 128.

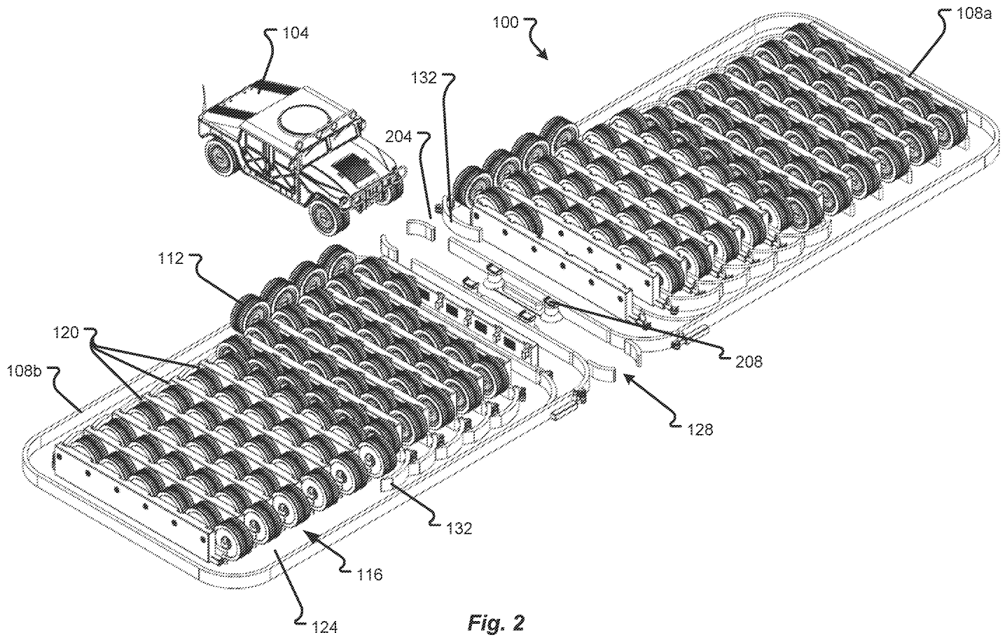

As shown in FIG. 2, when an actuator moves the paddles 132 at the entry of the refueling area 128 into an open position, the vehicle 104 may have a path to travel into the refueling area 128. Specifically, moving the paddles 132 at the entry of the refueling area 128 may expose an entry path 204 through which the vehicle 104 may travel. Before, while, or after the vehicle 104 passes through the entry path 204, one or more replacement wheels 112 may be moved around the wheel travel lane 124 of the first side 108a and second side 108b so that the replacement wheels 112 are in position to replace the wheels 112 already on the vehicle 104. The wheels 112 on the vehicle 104 may, presumably, be out of power, charge, or the like. Alternatively or additionally, some other component of the wheel(s) 112 on the vehicle 104 may have failed or require maintenance, meaning that the wheel(s) 112 need to be replaced with a replacement wheel 112 from the refueling system 100.

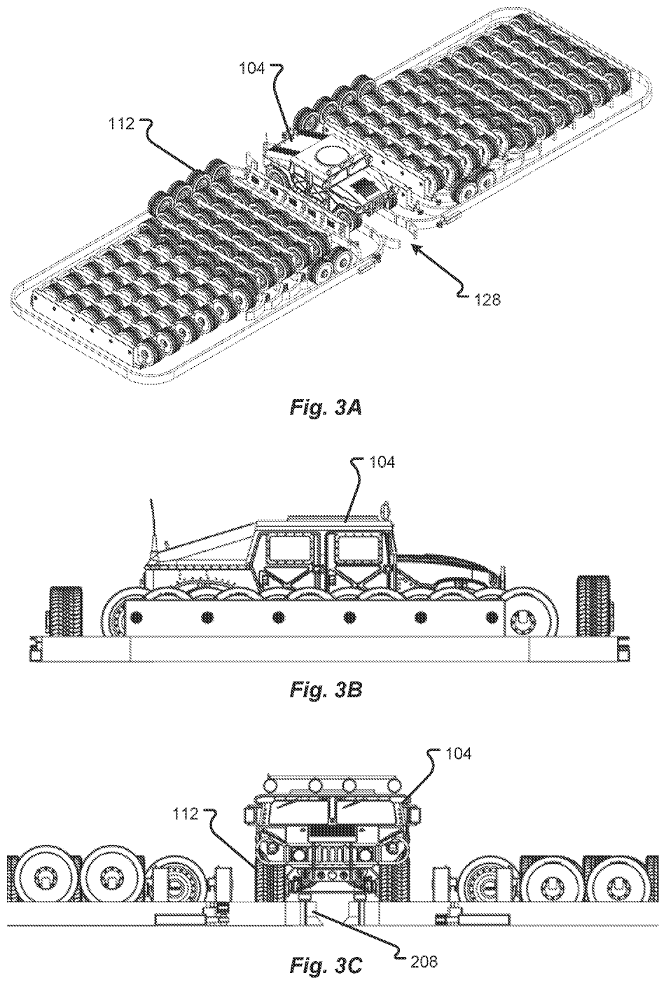

FIGS. 3A-3C illustrate how a vehicle 104 may enter the refueling area 128 until such time as the vehicle 104 is positioned over one or more lifts 208 in the refueling area 128. At this point, the vehicle 104 may still have its wheels 112. One or more wheels 112 of the vehicle 104 may be replaced using the refueling system 100 and the method described herein.

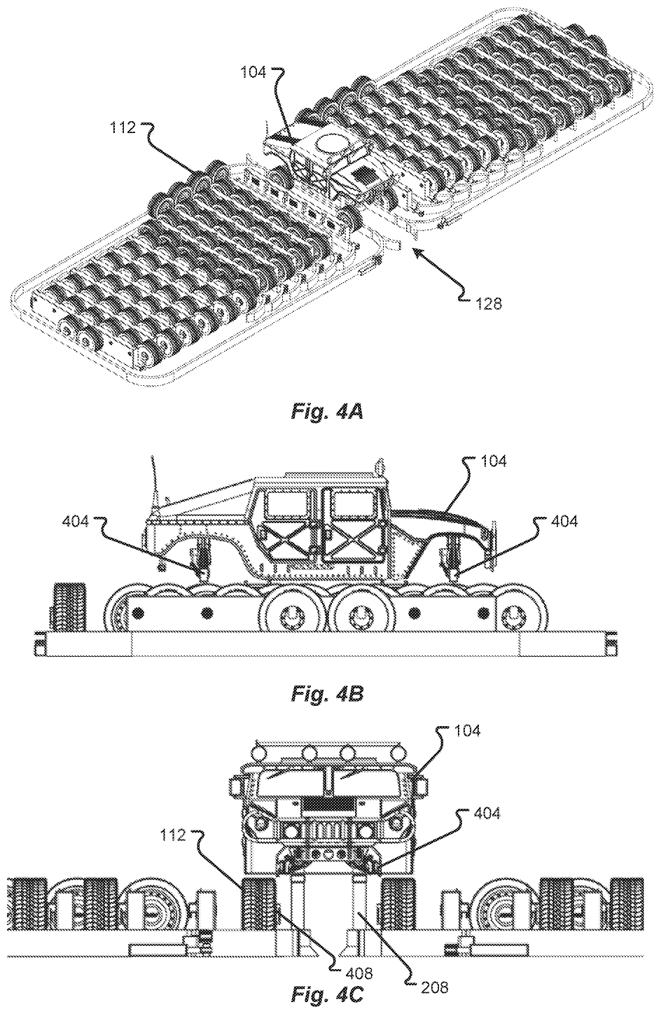

Specifically, as shown in FIGS. 4A-4C, the lifts 208 may be actuated or moved from a lowered position into a raised position. When the vehicle 104 is positioned over the lifts 208, the vehicle 104 (or vehicle frame) may be lifted upward relative to the ground. In some embodiments, the vehicle 104 may be lifted to a height at which no more vehicle 104 weight is supported by the wheel(s) 112. The lift height needed to achieve the state of lifting the vehicle 104 away from wheel support may vary depending upon the height and construction of the vehicle 104.

In some embodiments, the vehicle 104 (or vehicle frame) may be lifted to a height sufficient to uncouple the wheels 112 from the vehicle frame. As a non-limiting example, the vehicle frame may include one or multiple couplings 404 that mated with a coupling receiver 408 on each wheel 112 of the vehicle 104. The couplings 404 and coupling receivers 408 may be configured to hold or secure the wheels 112 to the vehicle 104 under normal operations; however, the couplings 404 and/or coupling receivers 408 may be configured to quickly couple and/or uncouple. In the depicted example, a latch, lever, or the like may be actuated to release the coupling 404 from the coupling receiver 408 prior to lifting the vehicle 104 away from the wheels 112. Without releasing the coupling 404 from the coupling receiver 408, the vehicle 104 may be lifted and still retain the wheels 112. By releasing the coupling 404 from the coupling receiver 408, the frame of the vehicle 104 may be lifted away from the wheels 112 under actuation of the lifts 208.

Once the vehicle 104 frame has been lifted away and the coupling 404 has become uncoupled from the coupling receiver 408, the wheels 112 may be free to move without the vehicle 104. Although FIGS. 4A-4C illustrate the coupling receiver 408 as being mounted on a wheel 112, it should be appreciated that the coupling receiver 4108 may be mounted on the vehicle 104 frame while the coupling 404 could be mounted on the wheel 112 without departing from the scope of the present disclosure.

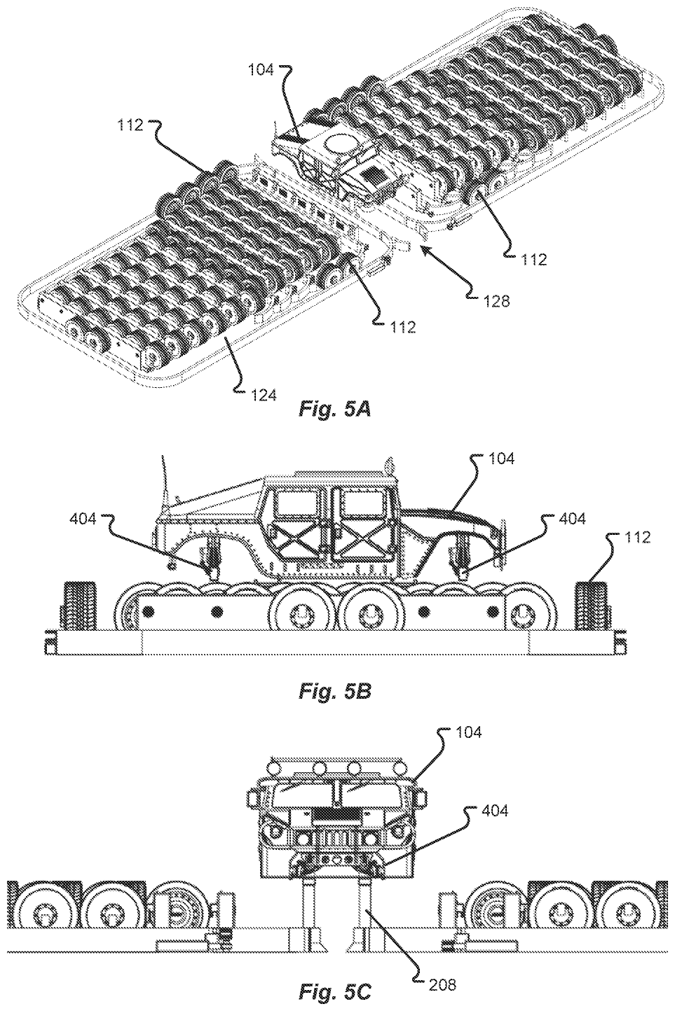

FIGS. 5A-5C illustrate how the old wheels 112 may be rolled away from the vehicle 104 through the vehicle travel lane 124. In some embodiments, the vehicle 104 is still lifted while all of the wheels 112 being replaced are rolled away from the refueling area 128 and into the wheel travel lane 124. It may also be possible to take the old wheels 112 out of the refueling system 100. With the old wheels 112 removed, the couplings 404 on the vehicle 104 are free to couple with coupling receivers 408 of new or replacement wheels 112.

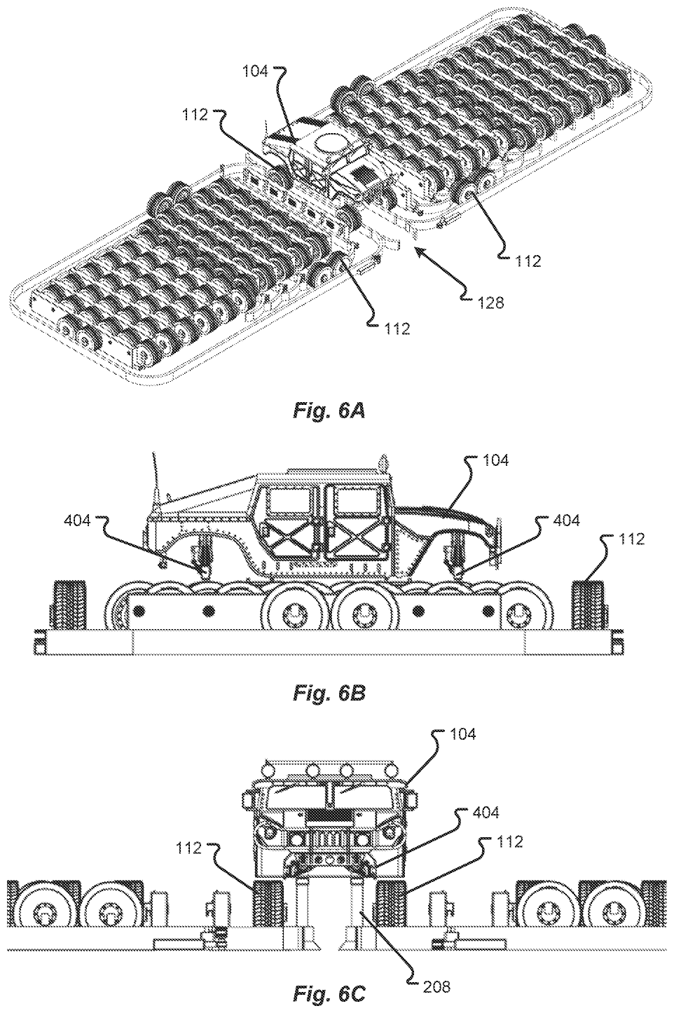

FIGS. 6A-6C illustrate a configuration of the refueling system 100 when the replacement wheels 112 are moved into position underneath the vehicle 104 frame. In some embodiments, the replacement wheels 112 may be positioned such that the coupling receivers 408 of the replacement wheels 112 are in a position to receive the couplings 404 of the vehicle 104 when the vehicle 104 frame is lowered.

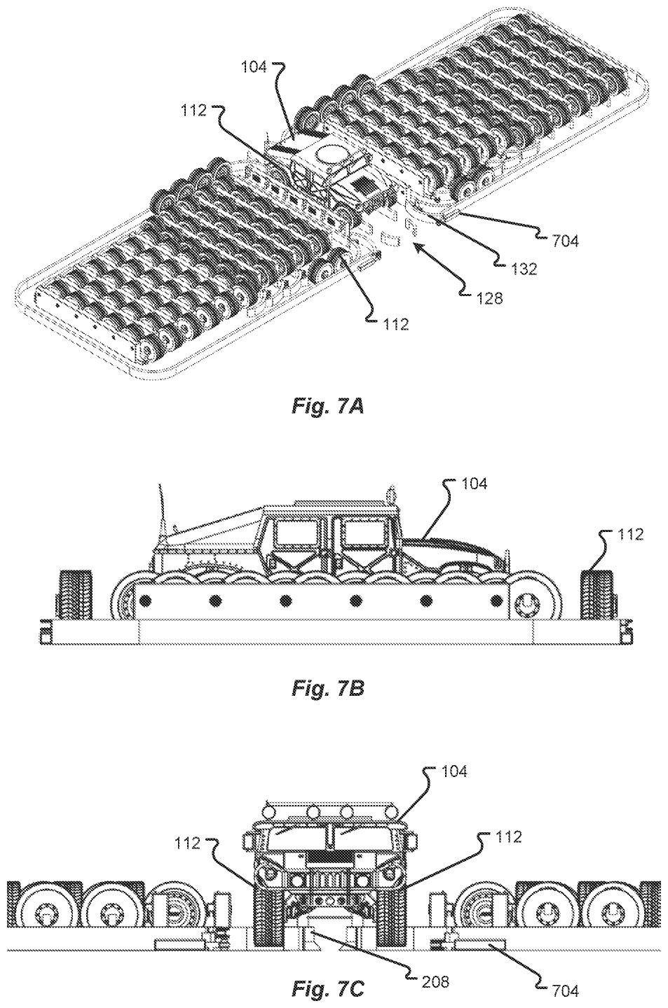

FIGS. 7A-7C illustrate a configuration of the refueling system 100 when the vehicle 104 frame has been lowered under a downward motion of the lifts 208. In some embodiments, when the couplings 404 have been secured to the coupling receivers 408 of the replacement wheels 112, one or more exit paddles 132 may be moved, thereby exposing an exit of the refueling area 128. As mentioned above, some or all of the paddles 132 may be actuated or controlled by an actuator 704. An actuator 704 may correspond to any type of pneumatic, hydraulic, servo motor, spring-biased mechanism, or the like. In other words, any type of device capable of moving a paddle 132 between a first position and second position may be used as an actuator 704 without departing from the scope of the present disclosure.

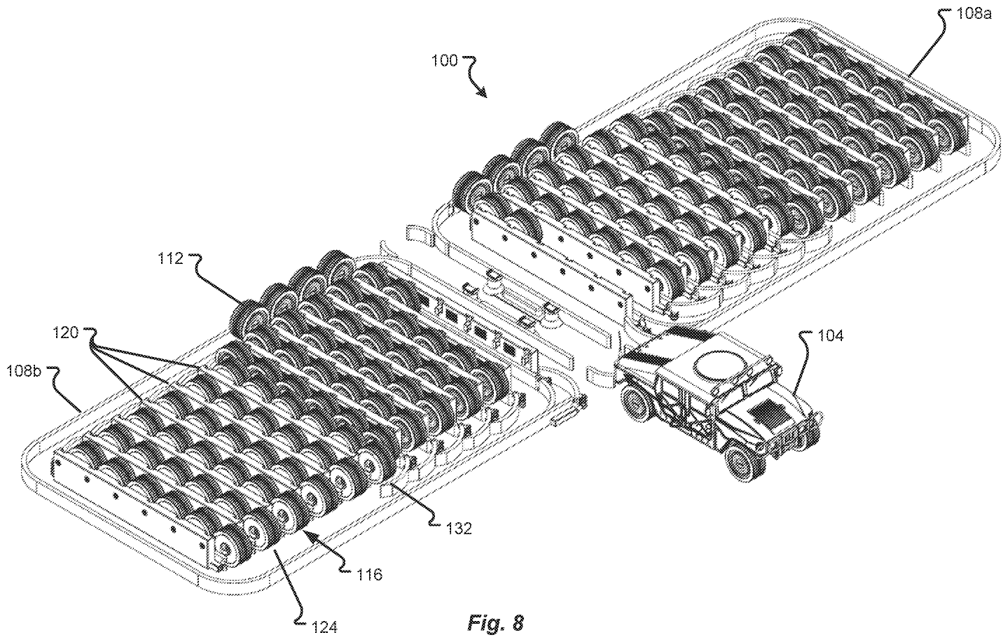

With the paddles 132 at the exit of the refueling area 128 opened, the vehicle 104 may be allowed to leave the refueling area 128. As an example, the vehicle 104 may be allowed to drive out of the refueling area 128 under power of one or more new wheels 112 as shown in FIG. 8.

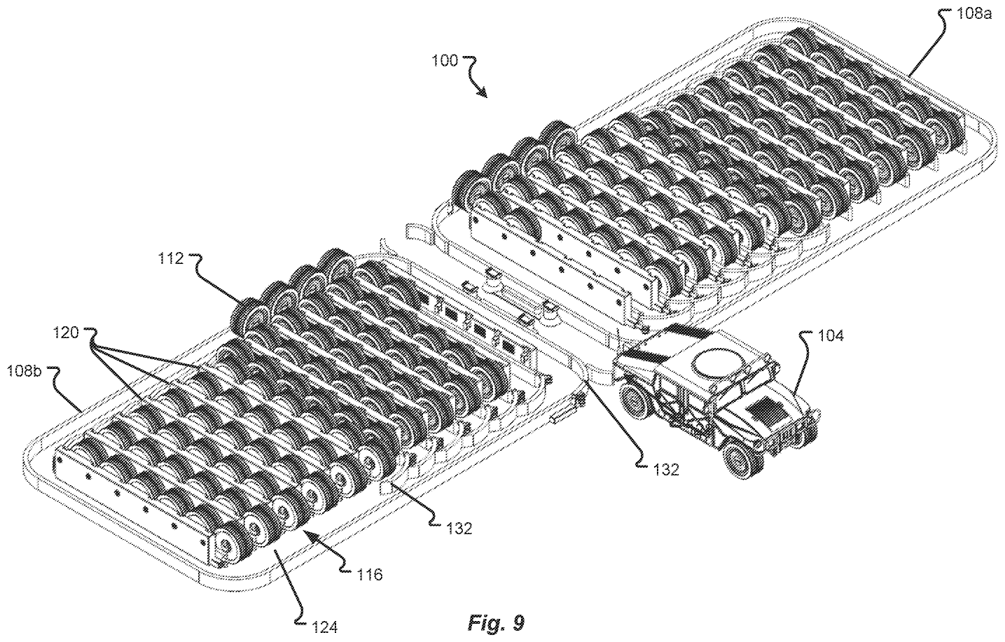

After the vehicle 104 has exited the refueling area 128, the paddles 132 at the exit of the refueling area 128 may be closed as shown in FIG. 9. At this point, the refueling area 128 may be closed until such time as another vehicle 104 approaches the refueling system 100 and one or more paddles 132 are opened to expose the refueling area 128. In some embodiments, entry to the refueling area 128 may be restricted such that only authorized vehicles 104 are permitted to enter the refueling area 128. As an example, the paddles 132 controlling entry to the refueling area 128 may be controlled by an authentication mechanism (e.g., vehicle identification system), a preconfigured remote-control device, or the like.

It should be appreciated that the refueling method or process depicted and described in connection with FIGS. 1-9 can enable a vehicle 104 to be refueled far more quickly than traditional vehicles. For instance, a vehicle 104 can be refueled in an amount of time needed to simply uncouple wheels 112 from the vehicle 104, lift the vehicle 104, rolls the old wheels 112 out from under the vehicle 104 frame, roll replacement wheels 112 under the vehicle 104 frame, lower the vehicle 104 frame, and connect the couplings 404 to the coupling receivers 408 of the replacement wheels 112. To the extent that the coupling and uncoupling of wheels 112 and the vehicle 104 is relative quick and efficient, the vehicle 104 can be refueled in a very efficient manner.

Various vehicle 104 configurations illustrate a four-wheel embodiment of the present disclosure. It should be appreciated that a vehicle may be configured to support any number of wheels (e.g., 1, 2, 3, 4, 5, . . . , 10, etc.) without departing from the scope of the present disclosure.

Moreover, various different configurations of a refueling system 100 are also contemplated. As a non-limiting example, a refueling system 100 may be configured to include one or many refueling areas 128. In some embodiments, a refueling system 100 is contemplated to include a plurality of refueling areas 128 in which a plurality of vehicles 104 can be refueled simultaneously with one another. For example, a plurality of refueling areas 128 may each be configured with their own dedicated wheel rows 116. In another example, two or more refueling areas 128 may share wheel rows 116 or receive charged wheels 112 from a common source of charged wheels 112. Said another way, one of the wheel rows 116 may feed charged wheels 112 to a first refueling area 128 and a second refueling area.

It should also be appreciated that the wheel rows 116 do not necessarily need to be configured as depicted. For instance, a collection of charged wheels 112 may be organized as columns or pillars of wheels 112, which are dropped to the ground to replace old wheels 112 on the vehicle 104. The used wheels 112 may be lifted toward the top of the column of wheels where they can be held or charged, as desired. Thus, a collection of charged and uncharged wheels 112 may be organized in any suitable fashion without departing from the scope of the present disclosure. The illustration of wheel rows 116 is intended to facilitate an efficient understanding of the inventive concepts described herein.

In some embodiments, the refueling system 100 may not necessarily need to include a charger device (e.g., a component responsible for charging uncharged or used wheels 112). Specifically, a refueling system 100 may include a plurality of charged wheels 112, but the wheels 112 may be charged from an external source. Said another way, a refueling system 100 may include charged and uncharged wheels 112 and may or may not include a charger device that is configured to charge or re-charge uncharged or used wheels 112.

The refueling system 100 may also be provided in a number of different form factors. For example, the components of the refueling system 100 may be provided on a portable/conveyable device. In a more specific but non-limiting example, the wheels 112 and other components of the refueling system 100 may be provided in a portable shipping container and the vehicle 104 may be configured to drive through the container to have used wheels 112 exchanged with charged wheels 112 that are also carried in the container. As another non-limiting example, the refueling system 100 may be provided on a trailer of a vehicle, thereby enabling the refueling system 100 to easily move from one location to another (e.g., creating a portable refueling system 100). As yet another non-limiting example, the refueling system 100 may be included as part of a vehicle frame, meaning that a vehicle 104 itself may include components of a refueling system 100. In such an embodiment, the vehicle 104 include components of the refueling system 100 may be considered a movable refueling system 100 itself.

Embodiments of the present disclosure have discussed the lifting of a vehicle 104 by way of lifts 208. The lifts 208 are illustratively depicted as hydraulic lifts that elevate the frame of the vehicle 104 as part of the recharging process. It should be appreciated that use of a hydraulic lift may be beneficial, but is not the only required approach. For instance, a vehicle 104 may be lifted using a crane or other type of hoist that pulls the frame of the vehicle 104 upwards to allow the wheels 112 of the vehicle 104 to be replaced. A refueling system 100 may also be configured to drop the ground beneath the wheels 112 while maintaining the frame of the vehicle 104 in substantially the same elevation. In other words, portions of the ground below the vehicle 104 may allow wheels to drop downwards relative to the vehicle 104 rather than requiring the vehicle 104 to be lifted.

Embodiments of the present disclosure further contemplate that the refueling system 100 may be used as a power source for other purposes. As an example, the charger device and/or charged wheels 112 may be connected to a power grid to provide at least some energy back into the power grid. It may also be possible to leverage at least some charge from the charged wheels 112 to power components other than vehicle 104 components. For instance, the wheels 112 sitting in the wheel rows 116 may be connected to a common power bus, which can be used to provide an alternative power source to other electrical components. In this way, the refueling system 100 may operate as an alternative power source or electric generator when the wheels 112 are not installed on a vehicle 104.

Specific details were given in the description to provide a thorough understanding of the embodiments. However, it will be understood by one of ordinary skill in the art that the embodiments may be practiced without these specific details. Additionally, the Figures do not depict well-known features that may be needed to create a working vehicle so as not to obscure the embodiments in unnecessary detail.

What is claimed is:

1. A refueling system, comprising:
a lift configured to lift and lower a vehicle frame;
a coupling and coupling receiver that releasably connects a wheel to the vehicle frame; and
a wheel travel lane that enables a replacement wheel to be rolled underneath the vehicle frame while the vehicle frame is lifted.

2. The refueling system of claim 1, wherein the coupling is provided on the vehicle frame and the coupling receiver is provided on the wheel.

3. The refueling system of claim 1, wherein the coupling is provided on the wheel and the coupling receiver is provided on the vehicle frame.

4. The refueling system of claim 1, wherein the lift comprises at least one of a pneumatic and hydraulic lift.

5. The refueling system of claim 1, further comprising:
a refueling area comprising the lift, wherein access to the refueling area is limited to authorized vehicles.

6. The refueling system of claim 1, wherein the wheel travel lane is established around a plurality of wheels.

7. The refueling system of claim 6, wherein the plurality of wheels are organized into at least one of rows and columns.

8. The refueling system of claim 7, wherein the rows and/or columns are established with one or more separators.

9. The refueling system of claim 1, further comprising:
a first side comprising a first plurality of replacement wheels to replace wheels on a first side of the vehicle; and
a second side comprising a second plurality of replacement wheels to replace wheels on a second side of the vehicle.

10. The refueling system of claim 9, wherein the replacement wheels comprises at least one of a power supply and a propulsion unit.

11. A refueling method, comprising:
uncoupling a wheel from a vehicle frame;
moving the wheel away from the vehicle frame;
moving a replacement wheel in proximity to the vehicle frame; and
coupling the replacement wheel to the vehicle frame.

12. The method of claim 11, wherein the replacement wheel comprises a power supply for a motor.

13. The method of claim 12, wherein the replacement wheel comprises a motor that is used to propel the vehicle.

14. The method of claim 11, wherein the replacement wheel comprises a coupling receiver and wherein the vehicle frame comprises a coupling, the method further comprising:
coupling the coupling receiver with the coupling.

15. The method of claim 11, further comprising:
lifting the vehicle frame relative to the wheel.

16. The method of claim 15, further comprising:
lowering the vehicle frame relative to the replacement wheel.

17. The method of claim 11, wherein the replacement wheel comprises at least one component positioned below an axis of rotation of the replacement wheel.

18. The method of claim 11, further comprising:
moving a paddle from a first position to a second position, thereby exposing an entry path to a refueling area.

19. The method of claim 11, wherein the vehicle frame is lifted with one or more pneumatic or hydraulic lifts to uncoupling the wheel from the vehicle frame.

20. The method of claim 11, wherein the wheel comprises one of a plurality of wheels that are connected to the vehicle frame.

21. A refueling system, comprising:
a refueling area configured to accept a vehicle;
one or more charged wheels in proximity to the refueling area; and
a wheel travel lane that enables a replacement wheel from the one or more charged wheels to be rolled underneath the vehicle thereby refueling the vehicle.

22. The refueling system of claim 21, wherein the one or more charged wheels and the wheel travel lane are provided in a portable format.

23. The refueling system of claim 22, wherein the portable format comprises at least one of a portable container and a trailer.

24. The refueling system of claim 21, further comprising a lift that is configured to elevate the vehicle within the refueling area.

25. The refueling system of claim 21, further comprising:
a second refueling area adjacent to the refueling area, wherein the refueling area and the second refueling area both receive charged wheels from a common collection of charged wheels.
